(19) United States
(12) Patent Application Publication
(10) Pub. No.: US 2008/0308127 A1
(43) Pub. Date: Dec. 18, 2008

(54) Dishwasher and Operating Method for a Dishwasher

(75) Inventors: Klaus Padtberg, Offenburg (DE); Bjorn Brodowski, Hohberg (DE)

Correspondence Address: THOMPSON HINE LLP;Intellectual Property Group, P.O Box 8801, DAYTON, OH, 45401-8801, US

(73) Assignee: PREMARK FEG L.L.C., Wilmington, DE (US)

(21) Appl. No.: 11/570,832

(22) PCT Filed: Jun. 17, 2005
(86) PCT No.: PCT/US05/21849

§ 371 Date: Dec. 18, 2006

(30) Foreign Application Priority Data
Jun. 22, 2004 (DE) 10 2004 030 013.5

(51) Int. Cl. B08B 7/00; A47L 15/46

(52) U.S. Cl. 134/18; 134/56 D

(57) ABSTRACT

A dishwasher (2) has a detecting device (4) for sensing at least one condition indicative of need for self-cleaning of the dishwasher. The detecting device (4) emits a signal in this respect, for example, to an indicating device (6) or to a control device (8). The control device (8) is designed for executing a self-cleaning program, for controlling: a) a device for supplying self-cleaning liquid, b) a circulating pump for circulating the self-cleaning liquid in the dishwasher, for cleaning parts of the same, and c) a device for emptying the self-cleaning liquid from the dishwasher following the self-cleaning operation according to step b).

### TECHNICAL FIELD

This application relates to a dishwasher for washing dishes and other items to be washed, for example trays or grease filters of a vapour extraction device, and to an operating method for such a dishwasher.

### BACKGROUND

Dishwashers and operating methods for dishwashers are known from the art. A dishwasher may be, in particular, a commercial dishwasher. Examples of known commercial dishwashers are hand-loaded programmable machines and dishwashers with conveying systems. Hand-loaded programmable machines are typically designed for receiving one or two baskets or racks for accommodating items to be washed. Loading with items to be washed may take place for example from the front (front-loading machines) or from the side, such as for example in the case of basket push-through machines. Examples of dishwashers with a conveying system are basket conveying machines or conveyor-belt machines.

Dishwashers contain a washing system with a number of spray nozzles for spraying washing liquid or rinsing liquid. The washing liquid may generally contain essentially drinking water, to which a surfactant, alkaline dishwashing detergent is added. Rinsing liquid may generally contain essentially drinking water or drinking water with an added rinsing agent.

The spray nozzles may be provided on a movable, for example rotatable, spray arm or on a fixedly installed spray tube, depending on the type of dishwasher used. There are known dishwashers which use the same spray nozzles for spraying the rinsing liquid as are used for spraying the washing liquid. Furthermore, there are known programmable machines and conveying-system dishwashers which use separate spray nozzles for spraying the rinsing liquid and the washing liquid.

The washing liquid is generally in a tank which is arranged in such a way that it collects washing liquid running off the dishes and, depending on the type of dishwasher, also rinsing liquid running off the dishes. A tank screen is generally provided, to hold back large contaminants contained in the liquid running off the dishes. To save energy, the washing liquid may be partly recirculated, i.e. some of the washing liquid is used for a further load of the dishwasher.

Usually, of the washing system of a dishwasher, only the tank screen is regularly cleaned by the user. The rest of the washing system is rarely cleaned by the user; in particular, the spray arms are only rarely removed from the machine and cleaned by the user. The interior space of the machine is also only rarely cleaned by the user. Apart from the tank screen, the cleaning of the dishwasher is generally performed by service personnel. After lengthy use, there are also often limescale deposits in the machine, which then have to be removed by a descaling agent—usually likewise by service personnel. This procedure is labour-intensive and costly.

It would be desirable to provide a dishwasher and an operating method for a dishwasher which make it possible in a simple and inexpensive way for the dishwasher to operate reliably for a sustained period of time and with a satisfactory level of hygiene.

### SUMMARY

In one aspect, a dishwasher contains a detecting device for sensing at least one condition indicative of a need for self-cleaning of the dishwasher. On this basis, the detecting device emits a signal. If two or more such operating conditions can be sensed by the detecting device, the detecting device may be designed in such a way that it emits the signal if the at least two operating conditions exist. Alternatively, it may be designed in such a way that it emits the signal if only one of the at least two operating conditions exists.

The dishwasher also has a control device, for executing a self-cleaning program, that is for controlling
a) a device for supplying self-cleaning liquid,
b) a circulating pump for circulating the self-cleaning liquid in the dishwasher, for cleaning parts of the same, and
c) a pump for pumping away the self-cleaning liquid from the dishwasher following the self-cleaning operation according to step b).

The signal of the detecting device makes it possible for the self-cleaning program to be executed without a user having to inspect the dishwasher to ascertain whether self-cleaning is required. This increases the user-friendliness of the dishwasher. In addition, the detecting device ensures that the self-cleaning operation is not forgotten by the user, which increases the operational reliability. Moreover, it is often only when the machine is partly dismantled that a user or service engineer can establish that self-cleaning is required. This is not necessary in the case of a dishwasher according to the invention. As a result, the servicing of the dishwasher according to the invention is also less cost-intensive than in the case of known dishwashers.

The dishwasher preferably has an indicating device for picking up the signal of the detecting device, the indicating device, on the basis of the signal, emitting an optical and/or acoustic signal for a user, who is thus alerted that self-cleaning of the dishwasher is required. The indicating device may be, for example, a lamp. As an alternative or in addition, the indicating device may have a display, which informs the user that self-cleaning is required. As an alternative or in addition to the optical signal, the indicating device may emit an acoustic signal, for example a continuous tone or a periodic audible signal.

An condition indicative of need for self-cleaning may be an operating condition such as, for example, a duration which has elapsed since the last self-cleaning operation. For this purpose, a duration which has elapsed since the last self-cleaning operation can be determined in the detecting method and the signal emitted when this duration is greater than a pre-stored duration threshold value. For example, the self-cleaning signal may be emitted every X days or every Y weeks. For this purpose, the detecting device preferably has the following elements: a real-time clock and a memory which stores the point in time of the last self-cleaning operation; a calculating device which, from the point in time of the last self-cleaning operation and a time signal from the real-time clock, calculates a duration which has elapsed since the last self-cleaning operation; a memory for storing the duration threshold value; and a time comparator by means of which the duration which has elapsed since the last self-cleaning operation is compared with the duration threshold value and the signal is emitted when the duration which has elapsed since the last self-cleaning operation is equal to or greater than the duration threshold value. The real-time clock may have its own time base, for example a quartz mechanism, or it may rely on an external time base, for example it may be designed as a radio clock which receives a time signal from an atomic clock.

The duration which has elapsed since the last self-cleaning operation also provides to a certain extent an indication of limescaling of the dishwasher. Recording the duration which has elapsed since the last self-cleaning operation is meaningful in particular if a washing program is carried out only rarely, for example once a day or every 2 days.

According to a further embodiment, the signal is emitted by the detecting device on the basis of an elapsed duration in which the dishwasher has been in operation. Then, a number of elapsed hours since the last self-cleaning operation is recorded and the signal emitted when the number of elapsed hours is greater than a pre-stored elapsed-hour threshold value. In this case, the detecting device has the following components: an elapsed-hour meter and an elapsed-hour resetter which resets the elapsed-hour meter as the self-cleaning program is executed; a memory for storing the elapsed-hour threshold value and an elapsed-hour comparator by means of which a meter reading of the elapsed-hour meter is compared with the elapsed-hour threshold value and the signal is emitted when the meter reading is equal to or greater than the elapsed-hour threshold value.

The signal may be emitted by the detecting device on the basis of a number of operating cycles of the dishwasher. For example, a number of washing cycles since the last self-cleaning operation may be counted in the detecting method and the signal emitted when the number of washing cycles is greater than a pre-stored cycle threshold value. For this purpose, the detecting device may comprise the following elements: a cycle meter, for counting washing-program cycles, and a cycle resetter which resets the cycle meter as the self-cleaning program is executed; a memory for storing the cycle threshold value and a cycle comparator by means of which a current value of the cycle meter is compared with the cycle threshold value and the signal is emitted when the current value of the cycle meter is equal to or greater than the cycle threshold value.

With the cycle meter—as also with the elapsed-hour meter—indirect sensing of contamination or limescaling is possible.

In a simple embodiment, it may be provided that the cycle meter is incremented by a constant value, irrespective of the type of operating cycle. This makes it possible for the operating cycle meter to be realized in a simple form. In order to increase the accuracy of detecting the necessity for a self-cleaning operation, however, it may also be provided that, with every operating cycle, the operating cycle meter is incremented by a value which depends on the type of operating cycle. For example, it may be provided that an intensive program increments the value of the operating cycle meter by twice the amount than a normal program.

The signal may be emitted by the detecting device on the basis of a directly sensed contamination of the dishwasher. For example, a degree of contamination of the dishwasher may be sensed in the detecting method and the signal emitted when the degree of contamination is greater than a pre-stored contamination threshold value.

According to one embodiment, for this purpose the detecting device comprises the following elements: at least one sensor for sensing a degree of contamination of the dishwasher, a memory for storing the contamination threshold value and a contamination comparator by means of which a current value of the degree of contamination is compared with the contamination threshold value and the signal is emitted when the current value of the degree of contamination is equal to or greater than the contamination threshold value.

The sensor may be any known sensor that is suitable for the purpose according to the invention. For this purpose, the sensor preferably detects a state of a component of the dishwasher that changes with the contamination. A sensor may be, in particular, an ultrasonic sensor or an optical sensor. For example, an ultrasonic sensor may measure an ultrasonic transmission property of a liquid line or a spray tube, for example, which changes with the contamination.

If two or more sensors are provided, the contamination comparator may compare the degree of contamination sensed by each individual sensor with a contamination threshold value assigned to this sensor. According to one embodiment, the contamination comparator is designed in such a way that it emits the signal when one of the sensors senses a degree of contamination which lies above the assigned contamination threshold value. According to another embodiment, it is provided that the contamination comparator determines an overall degree of contamination of the dishwasher from the values of all the sensors and compares it with a contamination threshold value assigned to this overall degree of contamination.

The direct sensing of contamination of the dishwasher is a very accurate possible way of establishing the necessity for a self-cleaning operation. The other methods referred to above in each case sense an operating state which indirectly senses the contamination of the dishwasher. Direct sensing of the contamination is more accurate then indirect sensing, but the direct method involves greater expenditure than the indirect methods.

Of the elements of the detecting device, in particular the real-time clock, the calculating device, the time comparator, the elapsed-hour meter, the elapsed-hour meter resetter, the elapsed-hour comparator, the cycle meter, the cycle meter resetter, the cycle comparator, the sensor device and the contamination comparator, one or more or all of the elements may contain a discrete electronic circuit, an integrated circuit and/or a microprocessor.

The elements of the detecting device may each be realized individually. The elements may, however, be at least partly combined in groups. For example, the real-time clock, the calculating device and the time comparator may be realized by a circuit or by a computer program or a computer program module. Alternatively, it may be provided that, as long as they do not require discrete components, all the elements are realized by a single computer program, which is run on a central microprocessor of the dishwasher.

Memories assigned to the elements of the detecting device, for example the memory which stores the point in time of the last self-cleaning operation, the meters or the memories for the threshold values, may be formed as separate memory elements. Alternatively, it may be provided that these memories are memory cells of a higher-level memory, for example of a memory assigned to the central microprocessor.

The control device may contain a discrete electronic circuit, an integrated circuit and/or a microprocessor, for example the central microprocessor, on which a suitable computer program is run. The control device may have separate memory elements, in particular for storing programs, for example for storing the self-cleaning program or at least a washing program. Alternatively, it may be provided that the memories of the control device are memory cells of a higher-level memory, for example of the memory assigned to the central microprocessor.

The self-cleaning program may be executed automatically on the basis of the signal generated as the detecting method is executed. For this purpose, the detecting device is connected for signal transmission to the control device, for example via electrical lines, in order for the signal to be transmitted to the control device. The control device is designed for picking up the signal and executing the self-cleaning program on this basis.

Preferably, a signal is sent to the user when automatic execution of the self-cleaning program is imminent, in order that the user does not load the dishwasher with new items to be washed before the self-cleaning program is executed.

The dishwasher may have a suitable operating element for starting the self-cleaning program manually. For example, if a signal that execution of the self-cleaning program is required is sent to the user by the indicating device, he can remove dishes that are in the dishwasher after the washing cycle, arrange the self-cleaning agent in the supply section and subsequently start the self-cleaning program. Manual starting of the self-cleaning program ensures that the self-cleaning program is executed at a point in time that is suitable in the operational-organizational sequence.

The self-cleaning liquid is preferably formed by a self-cleaning agent and clean water. For this purpose, it may be provided that the self-cleaning agent is arranged in a supply section; for supplying the self-cleaning liquid, the machine is filled with clean water and the clean water is circulated in order to form the self-cleaning liquid from the self-cleaning agent and the clean water.

For this purpose, the dishwasher has the supply section, for accommodating the self-cleaning agent, and a controllable clean-water inlet, for filling the dishwasher with clean water. The clean-water inlet may comprise, for example, a pipeline which is connected to a water supply system, and a controllable valve, by which the pipeline can be closed. For supplying the self-cleaning liquid, the control device then operates the clean-water inlet, in order to fill the dishwasher with clean water. After or during the filling, the control device operates the circulating pump, in order to circulate the clean water in such a way, in particular via the supply position, that the clean water along with the self-cleaning agent forms the self-cleaning liquid.

The supply section may be a location that is present in any case in the dishwasher, for example a tank screen. Furthermore, the supply section may be a location specifically intended for accommodating the self-cleaning agent.

The self-cleaning agent is preferably in tablet form. In this case, the user also does not require any metering aids for metering the self-cleaning agent. Furthermore, he can place the self-cleaning agent on the tank screen, without the latter having to be designed in a special way for this, since the size of the holes in customary tank screens is smaller than the tablet.

The self-cleaning liquid is adapted to clear adhering remains of grime or the like from parts of the dishwasher, preferably at least one of the parts comprising the washing system and the interior machine space. The self-cleaning liquid is intended to keep the dishwasher clean, in particular in places that are difficult for a user to reach, and to prevent a build-up of grime in the washing systems. Preferably, a fresh fragrance is to flow through the interior space of the machine after cleaning, backing up the visual impression of a clean machine by a further sensory impression. The self-cleaning liquid may be adapted to counteract limescale deposits, in particular in their initial stages. This prevents the creation of relatively large lime spots or clogged washing nozzles. The self-cleaning liquid or the self-cleaning agent preferably contains at least one of the following active substances, with particular preference all of them:

cleaning agent

disinfectant

descaling agent

fragrance.

The dishwasher may have a tank for accommodating washing liquid. The tank is designed for accommodating washing liquid up to a predetermined level. For executing a washing program, in which items to be cleaned are treated with washing liquid, the tank may be filled with the washing liquid up to the predetermined level, at least some of the washing liquid being used for executing the washing program a number of times, and all the washing liquid being pumped away from the tank prior to the self-cleaning liquid being supplied.

For this purpose, a pump for pumping away the washing liquid may be provided. The pump for pumping away the washing liquid may be the same pump that is also used for pumping away the self-cleaning liquid, or a separate pump. Furthermore, the control device is designed for controlling the pump at the end of the washing program, with the result that at least some of the washing liquid remains in the dishwasher, and for controlling the pump prior to the self-cleaning liquid being supplied, in order for all the washing liquid to be pumped away.

The supply section preferably lies above the predetermined level in the tank. In this case, the self-cleaning agent may be arranged in the supply section once the washing program has ended and prior to the washing liquid being pumped away. This method offers the user maximum convenience and dependability. When there is an optical and/or acoustic signal from the indicating device after the last washing program, he can therefore remove the items to be washed from the machine, arrange the self-cleaning agent in the supply section, for example on the tank screen, and start the self-cleaning program by actuating the operating element.

The self-cleaning program may include a step “d) filling the dishwasher with washing liquid once the self-cleaning liquid has been pumped away from the dishwasher according to step c)”.

Step d) makes the dishwasher ready to execute washing programs immediately after the self-cleaning program is ended. This minimizes waiting times for a user. It may be provided that the indicating device indicates an end of the self-cleaning program to the user. For example, it may be provided that the optical signal of the indicating device is emitted up to the end of the self-cleaning program. In this way, the end of the self-cleaning program is indicated to the user by the optical signal “going out”. Furthermore, it may be provided that a display shows a plain-text message indicating the end of the self-cleaning program.

### BRIEF DESCRIPTION OF THE DRAWINGS

FIG. 1 shows an embodiment of a dishwasher according to the invention;

FIG. 2 shows the dishwasher from FIG. 1 with self-cleaning liquid supplied;

FIG. 3 schematically shows an embodiment of a detecting device according to the invention;

FIG. 4 schematically shows parts of an embodiment of a dishwasher according to the invention.

### DETAILED DESCRIPTION

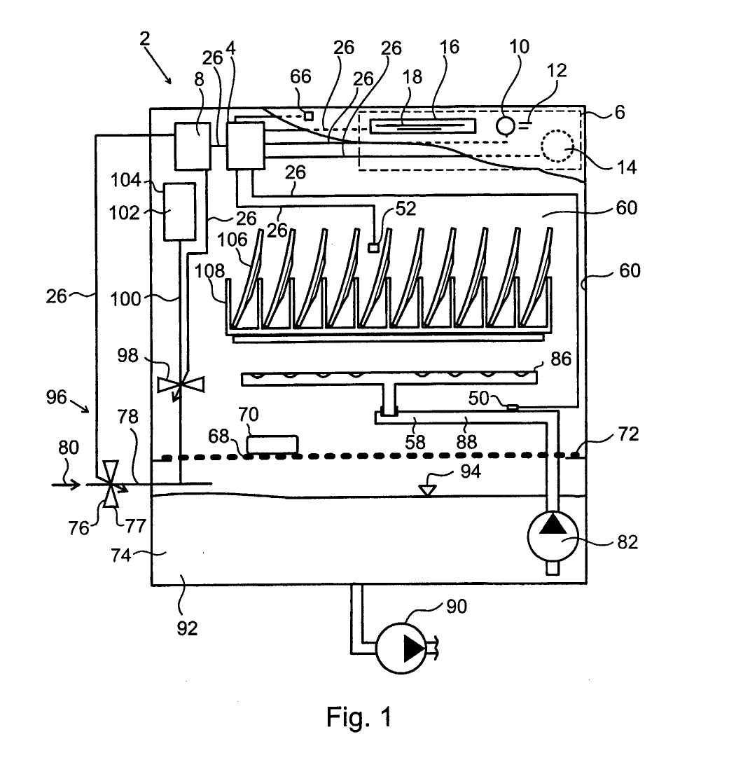

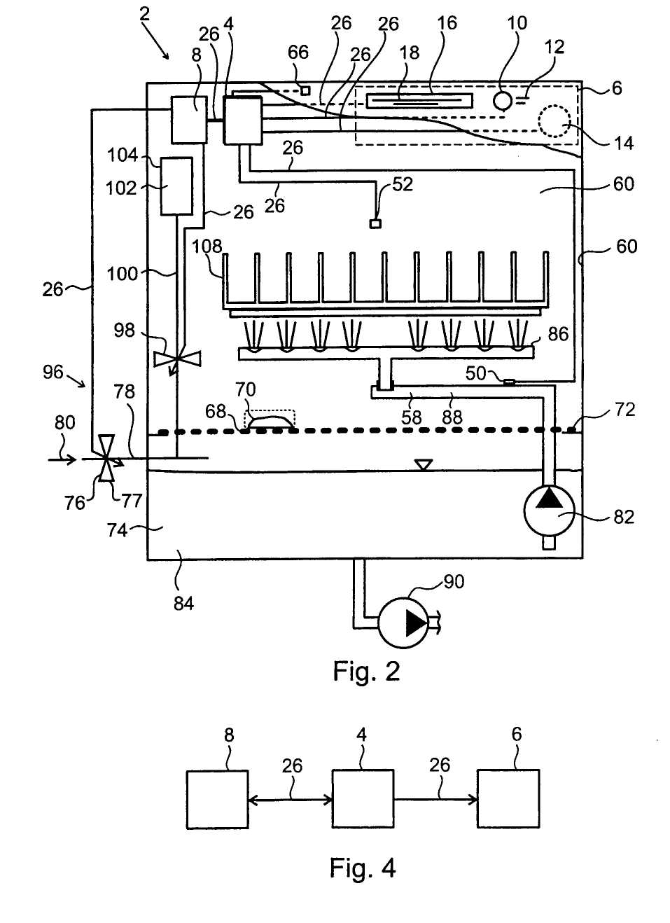

FIG. 1 and FIG. 2 show a dishwasher 2 in the form of a programmable machine for commercial use, with a detecting device 4 for sensing at least one operating condition which requires self-cleaning of the dishwasher 22, the detecting device 4 emitting a signal on this basis. The detecting device 4 is connected for signal transmission to an indicating device 6, here by electrical lines 26. On the basis of this signal, the indicating device 6 outputs for a user an optical and acoustic signal, which informs the user of the requirement for self-cleaning of the dishwasher 2. The dishwasher 2 also has a control device 8 for executing a self-cleaning program.

The indicating device 6 in FIG. 1 and FIG. 2 has a lamp 10, which is identified by an explanatory text 12 (for instance “self-cleaning”) or a corresponding pictogram. The indicating device 6 also has a buzzer 14, which is activated by the signal of the detecting device 4. Furthermore, the indicating device 6 of the dishwasher 2 has a display 16, which can show a message 18 in plain text, for example “self-cleaning required” as an additional optical signal.

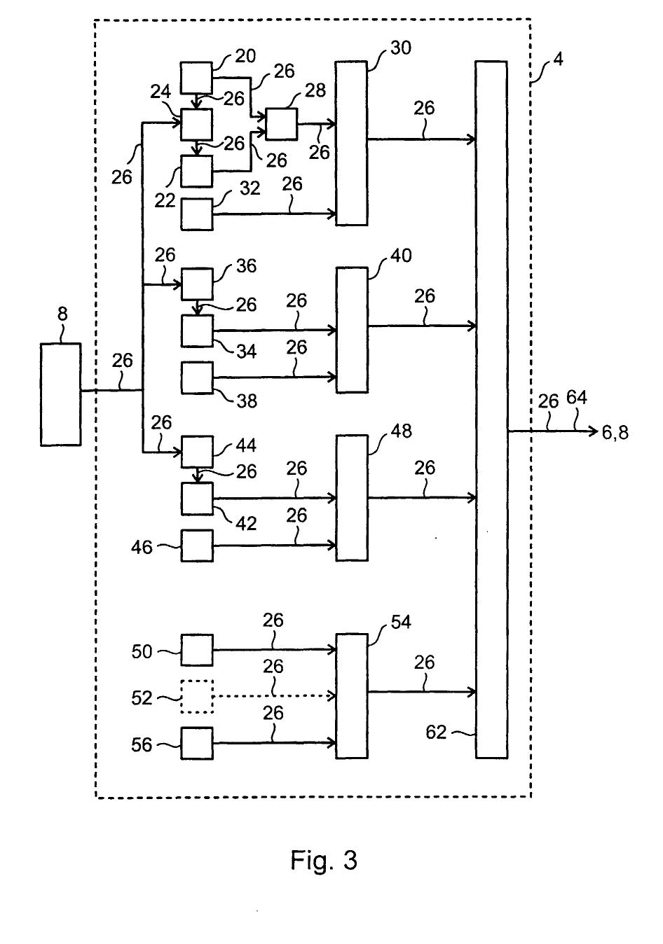

FIG. 3 schematically shows, in a synoptic representation, an embodiment of the detecting device 4 in detail. The embodiment represented in FIG. 3 serves for explaining a large number of possible ways of forming a detecting device, only a single one of which, or a combination of two of the possibilities represented, is preferably realized in practice.

The detecting device 4 has a real-time clock 20 and a memory 22, which stores a point in time of the last self-cleaning operation. The real-time clock 20 is connected to a time-memory device 24 by lines 26 for the transmission of a time signal. The control device 8 is connected for signal transmission to the time-memory device 24, in order to transmit a signal which signals the execution of the self-cleaning program to the time-memory device 24, which on this basis stores in the memory 22 a current time signal and consequently the point in time of the last self-cleaning operation. The real-time clock 20 is also connected for signal transmission to a calculating device 28, in order for a time signal to be transmitted to the calculating device 28, which calculates from the point in time of the last self-cleaning operation and the time signal of the real-time clock 20 a duration which has elapsed since the last self-cleaning operation.

A time comparator 30 is connected for signal transmission to a memory 32, in which a duration threshold value is stored. The time comparator 30 is also connected for signal transmission to the calculating device 28, in order for the duration which has elapsed since the last self-cleaning operation to be recorded. The time comparator 30 compares this with the duration threshold value and emits the signal when the duration which has elapsed since the last self-cleaning operation is equal to or greater than the duration threshold value.

The detecting device 4 in FIG. 3 also has an elapsed-hour meter 34 and an elapsed-hour resetter 36, connected to the latter for signal transmission. The control device 8 is connected for signal transmission to the elapsed-hour resetter 36, in order to transmit a signal which signals the execution of the self-cleaning program to the elapsed-hour resetter 36, which resets the elapsed-hour meter 34 on this basis.

The elapsed-hour meter 34 and a memory 38 for storing an elapsed-hour threshold value are connected for signal transmission to an elapsed-hour comparator 40, in order for a meter reading of the elapsed-hour meter 34 or of the elapsed-hour threshold value to be transmitted. The elapsed-hour comparator 40 compares the meter reading with the elapsed-hour threshold value and emits the signal when the meter reading is equal to or greater than the elapsed-hour threshold value.

Furthermore, the detecting device 4 has a cycle meter 42, for counting washing program cycles, and a cycle resetter 44. The control device 8 is connected for signal transmission to the cycle resetter 44, in order to transmit a signal which signals the execution of the self-cleaning program to the cycle resetter 44, which resets the cycle meter 42 on this basis.

The cycle meter 42 and a memory 46 for storing a cycle threshold value are connected for signal transmission to a cycle comparator 48, in order for a meter reading of the cycle meter 42 or the cycle threshold value to be transmitted. The cycle comparator 48 compares the meter reading with a cycle threshold value and emits the signal when the meter reading is equal to or greater than the cycle threshold value.

Finally, the detecting device 4 comprises a sensor 50 or alternatively a sensor 52 (represented by dotted lines) for sensing a degree of contamination of the dishwasher 2, which sensors are connected for signal transmission to a contamination comparator 54, in order for a current value of a variable characterizing the degree of contamination of the relevant sensor 50, 52 to be respectively transmitted. The detecting device 4 also has a memory 56 for storing a contamination threshold value which is adapted to the sensor 50, 52, which memory is connected for signal transmission to the contamination comparator 54, in order for the contamination threshold value to be transmitted. The contamination comparator 54 compares the current value of the degree of contamination of the sensor 50, 52 with the contamination threshold value and emits the signal when the current value of the degree of contamination of the sensor 50, 52 is equal to or greater than the contamination threshold value.

Signal outputs of the time comparator 30, of the elapsed-hour comparator 40, of the cycle comparator 48 and of the contamination comparator 54, which supply the signal of the relevant comparator 30, 40, 48, 54, are connected to a logic device 62, which picks up the signals of the comparators 30, 40, 48, 54, subjects them to logic operations and feeds them to a common output 64 of the detecting device 4. In FIG. 3, the logic device 62 is formed by an OR gate, which carries out an OR operation on the signals of the individual comparators 30, 40, 48, 54.

In an embodiment of the dishwasher 2 represented in FIG. 4, a detecting device 4 is connected for signal transmission to a control device 8, here by way of example by electrical lines 26, in order for the signal of the detecting device 4 to be transmitted to the control device 8. The control device 8 is designed for picking up the signal and executing the self-cleaning program on this basis. The execution of the self-cleaning program may take place after a predetermined waiting time, in which for example a user can remove dishes from the machine, or after completion of a washing program that is possibly in progress. The detecting device 4 is also connected to an indicating device 6, which outputs for a user a signal indicating the execution of the self-cleaning program.

The embodiment of a dishwasher 2 represented in FIG. 1 and FIG. 2 has an operating element 66 for manually starting the self-cleaning program controlled by the control device 8. In the self-cleaning program, firstly self-cleaning liquid 84 is supplied.

For this purpose, the dishwasher 2 has a supply section 68 for accommodating a self-cleaning agent 70. The supply section 68 is formed by a tank screen 72, which is arranged over a tank 74. The screen openings in the tank screen 72 are adapted for accommodating the self-cleaning agent 70 in tablet form.

The control device 8 is connected via electrical lines 26 to a controllable valve 76 as a clean-water inlet 77, which is arranged in a clean-water line 78, and controls said valve for filling the tank 74 with clean water 80. Arranged in the tank 74 is a circulating pump 82. After filling the tank 74, the control device 8 controls the circulating pump 82, connected to it for control, in order to circulate the clean water 80 in such a way that, with the self-cleaning agent 70 arranged on the tank screen 72, it forms the self-cleaning liquid 84. This is represented in FIG. 2, some of the self-cleaning agent 70 (here in tablet form) already having dissolved.

The control device 8 is also designed to control the circulating pump 82 after formation of the self-cleaning liquid 84 for further circulating the self-cleaning liquid 84 in the dishwasher 2 and for cleaning parts of the same. The parts to be cleaned comprise the washing system 58, in particular a spray arm 86 and a pipeline 88 for feeding liquids to the spray arm 86, and also the inside wall 60 of the dishwasher 2.

For pumping away liquid located in the tank 74, a pump 90 is provided and connected to the control device 8 for control purposes (not represented). The control device 8 controls the pump 90 after the self-cleaning operation to pump away the self-cleaning liquid 84, out of the dishwasher 2.

The tank 74 is also intended for accommodating washing liquid 92 up to a predetermined level 94, the supply section 68 lying above the predetermined level 94 in the tank 74. As represented in FIG. 1, the tank screen 72 is arranged above the predetermined level 94 of the washing liquid 92.

The dishwasher 2 represented in FIGS. 1 and 2 has as a controllable inlet 96 for washing liquid 92 the controllable valve 76 in the clean-water line 78 and a controllable valve 98 in a dishwashing agent feed line 100. The control device 8 is designed for supplying washing liquid 92 in the tank 74, to control the valve 76 in the clean-water line 78 and thereby feed clean water 80 into the tank 74 and to control the valve 78 in the dishwashing agent feed line 100, for metering dishwashing agent 102 out of a dishwashing agent reservoir 104 to the clean water 80.

The washing programs executed by the control device 8 are designed such that, at the end of a washing program in which items to be washed 106 are treated with the washing liquid 92 in a basket 108, at least some of the washing liquid 92 remains in the dishwasher 2, in order to save water and energy. Provided for pumping away the washing liquid 92 is the pump 90, with which the self-cleaning liquid 84 is also pumped away from the tank 74.

If a self-cleaning operation is required, the user waits until the end of the washing program and then places the self-cleaning agent 70 on the tank screen 72. This situation is represented in FIG. 1. The control device 8 of the dishwasher 2 represented in FIG. 1 and FIG. 2 is designed to control the pump 90 when the operating element 66 is actuated to pump away all the washing liquid 92 before the self-cleaning liquid 84 is supplied, and to subsequently control the self-cleaning program.

The control device 8 is also designed to control the controllable inlet 26 for washing liquid 92, in order to fill the tank 74 up to the predetermined level 94 with washing liquid 92 once the self-cleaning liquid 84 has been pumped away.

A preferred embodiment of a self-cleaning program includes the following steps:
0. The self-cleaning agent (tablet/powder/liquid) is supplied in a metered manner.
1. The washing liquid is pumped away from the tank 74.
2. The dishwasher 2 is filled with clean water 80, without dishwashing agent 102 being supplied in a metered manner.
3. The clean water 80 is circulated through the washing system 58, which also serves for cleaning items to be washed 106. In this case, the self-cleaning agent dissolves (along with the clean water, the self-cleaning liquid forms) and cleans the interior space of the machine and also the washing system 58.
4. The self-cleaning liquid is pumped away.
5. The dishwasher 2 is filled as in “normal operation”, with dishwashing agent 102 being supplied in a metered manner.

The invention is not restricted to the embodiments shown by way of example in the drawings and explained above. Rather, the invention is obtained by overall consideration by a person skilled in the art of the claims, the description and the embodiments that are provided by way of example.

What is claimed is:

1. A dishwasher, characterized by
a detecting device for sensing at least one condition indicative of a need for a self-cleaning of the dishwasher, the detecting device emitting a signal in this respect; and
a control device for executing a self-cleaning program, the control device operable for controlling
a) a device for supplying self-cleaning liquid,
b) a circulating pump for carrying out a self-cleaning operation by circulating the self-cleaning liquid in the dishwasher, for cleaning parts of the same, and
c) a device for emptying the self-cleaning liquid from the dishwasher following the self-cleaning operation according to step b).

2. The dishwasher according to claim 1, characterized in that the device for emptying the self-cleaning liquid from the dishwasher following the self-cleaning operation according to step b) is a pump.

3. The dishwasher according to claim 1, characterized in that the operation of emptying the self-cleaning liquid from the dishwasher following the self-cleaning operation takes place by gravitational force.

4. The dishwasher according to claim 1, characterized by an indicating device for picking up the signal of the detecting device, the indicating device, on the basis of this signal, emitting an optical and/or acoustic signal for a user, who is thus alerted that self-cleaning of the dishwasher is required.

5. The dishwasher according to claim 1, characterized in that the detecting device has:
a real-time clock and a memory which stores the point in time of the last self-cleaning operation;
a calculating device which, from the point in time of the last self-cleaning operation and a time signal from the real-time clock, calculates a duration which has elapsed since the last self-cleaning operation;
a memory for storing a duration threshold value; and
a time comparator by means of which the duration which has elapsed since the last self-cleaning operation is compared with the duration threshold value and the signal is emitted when the duration which has elapsed since the last self-cleaning operation is equal to or greater than the duration threshold value.

6. The dishwasher according to claim 1, characterized in that the detecting device has:
an elapsed-hour meter and an elapsed-hour resetter which resets the elapsed-hour meter as the self-cleaning program is executed;
a memory for storing an elapsed-hour threshold value;
and an elapsed-hour comparator by means of which a current value of the elapsed-hour meter is compared with the elapsed-hour threshold value and the signal is emitted when the current value of the elapsed-hour meter is equal to or greater than the elapsed-hour threshold value.

7. The dishwasher according to claim 1, characterized in that the detecting device has:
a cycle meter, for counting washing-program cycles, and a cycle resetter which resets the cycle meter as the self-cleaning program is executed;
a memory for storing a cycle threshold value; and
a cycle comparator by means of which a current value of the cycle meter is compared with a cycle threshold value and the signal is emitted when the current value of the cycle meter is equal to or greater than the cycle threshold value.

8. The dishwasher according to claim 1, characterized in that the detecting device contains:
at least one sensor for sensing the degree of contamination of the dishwasher;
a memory for storing a contamination threshold value; and
a contamination comparator (54) by means of which a current value of the degree of contamination is compared with the contamination threshold value and the signal is emitted when the current value of the degree of contamination is equal to or greater than the contamination threshold value.

9. The dishwasher according to claim 1, characterized in that the detecting device is connected for signal transmission to the control device, in order for the signal to be transmitted to the control device, and in that the control device is designed for picking up the signal and executing the self-cleaning program on this basis.

10. The dishwasher according to claim 1, characterized by an operating element for manually causing the control device to start the self-cleaning program.

11. The dishwasher according to claim 1, characterized by a supply section, for accommodating a self-cleaning agent, and a controllable clean-water inlet, for filling the dishwasher with clean water, the control device, for the purpose of supplying the self-cleaning liquid, operating the clean-water inlet, in order to fill the dishwasher with clean water, and operating the circulating pump, in order to circulate the clean water such that the latter, along with the self-cleaning agent, forms the self-cleaning liquid.

12. The dishwasher according to claim 11, characterized in that the supply section is configured for accommodating the self-cleaning agent in tablet form.

13. The dishwasher according to claim 12, characterized by a tank for accommodating washing liquid up to a predetermined level, the supply section being located above the predetermined level in the tank.

14. The dishwasher according to claim 1, characterized in that a pump is provided for pumping away washing liquid, and in that the control device is designed for controlling the pump at the end of a washing program, in which items which are to be washed are treated with the washing liquid, with the result that at least some of the washing liquid normally remains in the dishwasher, and for controlling the pump such that substantially all the washing liquid is pumped away prior to the self-cleaning liquid being supplied.

15. The dishwasher according to claim 1, characterized by a controllable inlet for washing liquid, and in that the control device is configured for controlling the inlet in order for the dishwasher to be filled with washing liquid following removal of the self-cleaning liquid from the dishwasher.

16. A method of operating a dishwasher, characterized by
a detecting method that checks whether at least one predetermined condition indicative of need for self-cleaning of the dishwasher is present, a signal being emitted if the at least one predetermined condition is present; and
a self-cleaning program that has the following steps:
a) supplying self-cleaning liquid;
b) circulating the self-cleaning liquid in the dishwasher, for cleaning parts of the dishwasher;
c) removing the self-cleaning liquid (84) from the dishwasher following the self-cleaning operation according to step b).

17. The method according to claim 16, characterized in that the signal emitted during the course of the detecting method is picked up by an indicating device, and in that, on this basis, the indicating device emits an optical and/or acoustic signal for a user.

18. The method according to claim 16, characterized in that a duration that has elapsed since the last self-cleaning operation is determined during the course of the detecting method, and in that the signal is emitted when this duration is greater than a pre-stored duration threshold value.

19. The method according to claim 16, characterized in that a number of hours elapsed since the last self-cleaning operation is sensed during the course of the detecting method, and in that the signal is emitted when the number of hours elapsed is greater than a pre-stored elapsed-hour threshold value.

20. The method according to claim 16, characterized in that a number of washing cycles since the last self-cleaning operation is counted during the course of the detecting method, and in that the signal is emitted when the number of washing cycles is greater than a pre-stored cycle threshold value.

21. The method according to claim 16, characterized in that the degree of contamination of the dishwasher is sensed during the course of the detecting method, and the signal is emitted when the degree of contamination is greater than a predetermined contamination threshold value.

22. The method according to claim 16, characterized in that a self-cleaning agent is arranged in a supply section and, for the purpose of supplying the self-cleaning liquid, the machine is filled with the clean water and the clean water is circulated via the supply section in order for the self-cleaning liquid to be formed from the self-cleaning agent and the clean water.

23. The method according to claim 22, characterized in that the self-cleaning agent is supplied in tablet form.

24. The method according to claim 22, characterized in that the self-cleaning agent is supplied in liquid form.

25. The method according to claim 22, characterized in that the self-cleaning agent is supplied in powder form.

26. The method according to claim 16, characterized in that, in order to execute a washing program in which dishes are treated with washing liquid, a tank is filled up to a predetermined level with the washing liquid, in that at least some of the washing liquid is used for executing the washing program a number of times, and in that all the washing liquid is pumped away from the tank prior to the self-cleaning liquid being supplied.

27. The method according to claim 22, characterized in that the supply section is located above the predetermined level of the washing liquid, and in that the self-cleaning agent is arranged in the supply section once the washing program has ended and prior to the washing liquid being pumped away.

28. The method according to claim 16, characterized in that the self-cleaning program contains the following step:
d) filling the dishwasher with washing liquid once the self-cleaning liquid has been pumped away from the dishwasher according to step c).

29. The method according to claim 16, characterized in that the self-cleaning program is executed automatically on account of the signal produced during the course of the detecting method.
